(19) United States
(12) Patent Application Publication
(10) Pub. No.: US 2006/0076864 A1
(43) Pub. Date: Apr. 13, 2006

(54) Electrodeless high power fluorescent lamp with controlled coil temperature

(75) Inventors: Oleg A. Popov, Needham, MA (US); Jakob Maya, Brookline, MA (US); Robert T. Chandler, Lexington, MA (US)

Correspondence Address: WOLF GREENFIELD & SACKS, PC;FEDERAL RESERVE PLAZA, 600 ATLANTIC AVENUE, BOSTON, MA, 02210-2211, US

(73) Assignee: Matsushita Electric Works Ltd., Osaka (JP)

(21) Appl. No.: 10/964,372

(22) Filed: Oct. 13, 2004

(51) Int. Cl. H01K 1/58; H01J 1/02; H01J 61/52; H01J 7/24

(52) U.S. Cl. 313/33

(57) ABSTRACT

An electrodeless lamp includes a bulbous lamp envelope enclosing an inert gas and a vaporizable metal fill, the lamp envelope having a reentrant cavity, a magnetic core positioned within the reentrant cavity, an induction coil disposed on the magnetic core, a cooling structure disposed inside the magnetic core, and a spacer structure between the magnetic core and an inside wall of the reentrant cavity. The spacer structure defines a thermally insulating gap between the magnetic core and the inside wall of the reentrant cavity to control coil/core temperature.

### FIELD OF THE INVENTION

This invention relates to electric lamps and, more particularly, to electrodeless fluorescent lamps which operate at frequencies from 20 kHz to 20 MHz and power levels in a range of 50 watts to 500 watts.

### BACKGROUND OF THE INVENTION

Electrodeless, inductively-coupled fluorescent lamps have been recently introduced into the market for indoor, outdoor, industrial and commercial applications. An advantage of electrodeless lamps is the absence of internal electrodes and heating filaments which are life-limiting factors in conventional fluorescent lamps. The life of electrodeless fluorescent lamps is substantially higher than that of conventional fluorescent lamps and can reach 100,000 hours.

A low and medium power (10-200 watts) electrodeless fluorescent lamp operated at a frequency of 20-1000 kHz is disclosed in U.S. Pat. No. 6,081,070, issued Jun. 27, 2000 to Popov et al. A bulbous lamp envelope with a reentrant cavity on its axis is fabricated of glass and is filled with inert gas (Ar, Kr, Xe) and mercury vapor. An inductively-coupled discharge is ignited and maintained in the lamp envelope by an azimuthal electric field induced in the envelope by a magnetic field. The magnetic field is generated by an induction coil wrapped around a ferrite core which is positioned in the reentrant cavity.

An exhaust tubulation is located on the cavity axis. A mercury amalgam is held in the tubulation by several glass pieces. The position of the amalgam is selected to keep the amalgam temperature between 80° C. and 120° C. within the ambient temperature range from −10° C. to +60° C. This provides in the lamp envelope an optimum mercury vapor pressure about 6×10⁻³ Torr.

To remove heat from the ferrite core so as to keep its temperature below the Curie point, a cooling structure is utilized. The cooling structure includes a cooling tube of high thermal conductivity metal or ceramic positioned inside the ferrite core, and a heat sink of a high thermal conductivity material located at the bottom of the lamp envelope. The cooling tube and the heat sink are thermally and electrically connected.

Such an arrangement maintained temperature of the ferrite core and induction coil wire below 200° C. at a lamp power up to 260 watts and an ambient temperature of +60° C. A further increase in lamp power leads to an increase in the power deposited on the walls of the reentrant cavity and transferred to the coil wire and ferrite core via convection and light radiation. Also, the increase in power absorbed by the inductive plasma results in an increase in power density on the cavity walls. As a result, the coil wire and ferrite core are heated to temperatures above 200° C., which causes deterioration of the coil wire and hence a reduction in lamp lifetime. To improve heat management, the thickness of the cooling tube inserted in the ferrite core can be increased. This can be achieved by reducing the cooling tube inner diameter. However, the decrease of the cooling tube inner diameter is limited by the finite diameter of the exhaust tubulation.

Accordingly, there is a need for improved electrodeless high power fluorescent lamps.

### SUMMARY OF THE INVENTION

According to a first aspect of the invention, an electrodeless lamp is provided. The electrodeless lamp comprises a bulbous lamp envelope enclosing an inert gas and a vaporizable metal fill, the lamp envelope having a reentrant cavity, an electromagnetic coupler positioned within the reentrant cavity, and a spacer structure disposed between the electromagnetic coupler and an inside wall of the reentrant cavity.

According to a second aspect of the invention, an electrodeless lamp is provided. The electrodeless lamp comprises a bulbous lamp envelope enclosing an inert gas and a vaporizable metal fill, the lamp envelope having a reentrant cavity, a magnetic core positioned within the reentrant cavity, an inductive coil disposed on said magnetic core, a cooling structure disposed inside said magnetic core, and a spacer structure between the magnetic core and an inside wall of the reentrant cavity.

The spacer structure may comprise two or more spaced-apart, thermally insulating rings positioned between the magnetic core and the inside wall of the reentrant cavity. The thermally insulating rings may have protrusions to reduce thermal conduction from the cavity wall to the magnetic core. The spacer structure may include a portion positioned between an end of the magnetic core and a closed end of the reentrant cavity. The spacer structure defines a thermally insulating gap between the magnetic core and the inside wall of the reentrant cavity.

According to a third aspect of the invention, a method is provided for enhancing performance of an electrodeless lamp including a bulbous lamp envelope having a reentrant cavity and an electromagnetic coupler positioned within the reentrant cavity. The method comprises controlling a spacing between the electromagnetic coupler and an inside wall of the reentrant cavity with a thermally insulating spacer structure.

### BRIEF DESCRIPTION OF THE DRAWINGS

For a better understanding of the present invention, reference is made to the accompanying drawings, which are incorporated herein by reference and in which:

FIG. 1 is a schematic cross-sectional view of a lamp assembly including an electrodeless fluorescent lamp and a base fixture in accordance with an embodiment of the invention;

FIG. 2A is a cross-sectional view of a spacer in accordance with an embodiment of the invention;

FIG. 2B is a top view of the spacer of FIG. 2A;

FIG. 2C is a top view of a spacer in accordance with another embodiment of the invention;

FIG. 2D is a cross-sectional view of a spacer structure in accordance with a further embodiment of the invention;

FIG. 2E is a cross-sectional view taken along the line 2E-2E of FIG. 2D;

FIG. 3 is a graph of lamp light output and efficacy as a function of the lamp power at a lamp operating frequency of 135 kHz and an ambient temperature of +25° C.;

FIG. 4 is a graph of coil power losses and lamp power efficiency as a function of lamp power at a lamp operating frequency of 135 kHz and an ambient temperature of +25° C.;

FIG. 5 is a graph of coil and ferrite temperatures as a function of ambient temperature at a lamp power of 235 watts and an operating frequency of 135 kHz; and

FIG. 6 is a graph of coil temperature as a function of a distance between the coil and the cavity walls.

### DETAILED DESCRIPTION

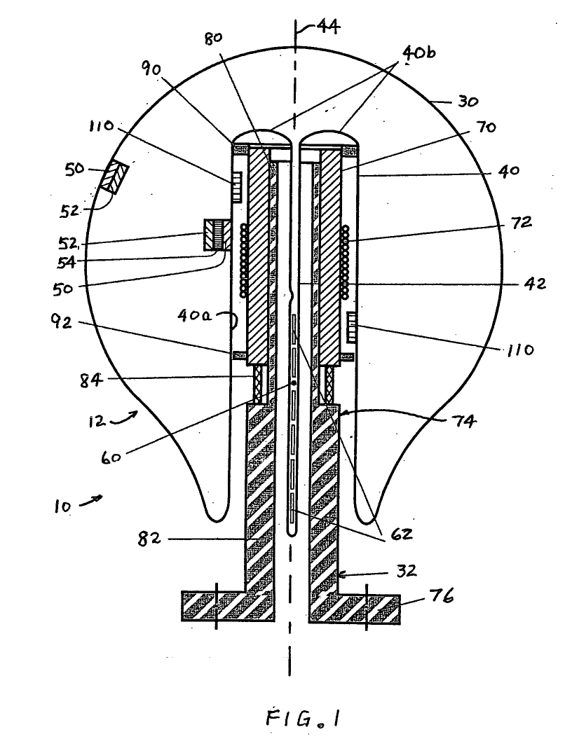

A simplified cross-sectional diagram of a lamp assembly in accordance with an embodiment of the invention is shown in FIG. 1. A lamp assembly 10 includes an electrodeless lamp 12 and a base fixture (not shown) for supporting lamp 12 and serving as a heat sink. Electrodeless lamp 12 includes a lamp envelope 30 and an electromagnetic coupler 32.

Lamp envelope 30 may be made from glass and may have a bulbous shape, as shown in FIG. 1. Lamp envelope 30 includes a reentrant cavity 40 with an exhaust tubulation 42 located inside reentrant cavity 40 on a cavity axis 44. Reentrant cavity 40 may have a generally cylindrical shape. The diameter of the lamp envelope 30 may be in a range of 100 mm (millimeters) to 300 mm and in a preferred embodiment is 180 mm. The height of lamp envelope 30 may be in a range of 100 mm to 350 mm and in a preferred embodiment is 250 mm. The diameter of reentrant cavity 40 may be in a range of 20 mm to 70 mm and in a preferred embodiment is 48 mm. An inert fill gas, such as Ar, Kr, or the like, may have a pressure in a range of 0.01 Torr to 5 Torr in lamp envelope 30. In a preferred embodiment, Ar at a pressure in a range of 20 to 100 mTorr is utilized. The inside wall of lamp envelope 30 and reentrant cavity 40 are coated with a protective coating 50 and a phosphor coating 52. The inside surface of reentrant cavity 40 (the surface exposed to the interior of the lamp envelope) sometimes can also be coated with a reflecting coating 54.

A mercury amalgam 60 is positioned in exhaust tubulation 42 and controls the mercury vapor pressure in the lamp envelope 30. Several glass pieces 62 hold the amalgam 60 in a fixed position that is optimum to provide mercury vapor pressure in lamp envelope 30 within a wide range of ambient temperatures.

Electromagnetic coupler 32 is located in reentrant cavity 40 and includes a magnetic core 70, an induction coil 72 and a cooling structure 74. The coupler 32 is connected thermally and electrically to the base fixture via a lamp base 76.

Induction coil 72 may be made from multiple strand wire, such as Litz wire, wound around magnetic core 70. The number of strands may be in a range of 7 to 470. The number of coil turns may be in a range of 10 to 100. In a preferred embodiment, the number of strands is 19 and the number of turns is 32. The magnetic core 70 may be made from a ferrite material, such as MnZn material, that has very low power losses at frequencies of 20 to 400 kHz, and has good thermal contact with cooling structure 74. Additional details of the ferrite core are provided in published U.S. application No. 2002/0067129 A1, which is hereby incorporated by reference. In a preferred embodiment, the outer diameter of magnetic core 70 is 32 mm the inner diameter is 16.5 mm. The length of magnetic core 70 may be in a range of 20 mm to 300 mm and in a preferred embodiment is 100 mm. The magnetic core 70 and induction coil 72 are positioned along cavity axis 44 so that the center of core 70 is approximately positioned where the diameter of the lamp envelope 30 is maximum. This location of the core 70 and coil 72 provides a low plasma electric field and hence a low magnetic field and associated core power losses.

Cooling structure 74 may include a cooling tube 80, an extension tube 82 and a coil spacer 84. The cooling tube 80 is made of a material having high thermal conductivity, such as Cu, Al, Al₂O₃, boron nitride, etc., and is disposed along cavity axis 44. In a preferred embodiment, cooling tube 80 is made of copper. The inner diameter of cooling tube 80 is larger than the outer diameter of exhaust tubulation 42. Cooling tube 80 is thermally and electrically connected to extension tube 82. In a preferred embodiment, cooling tube 80 and extension tube 82 are made as one piece, as shown in FIG. 1.

The outer diameter of cooling tube 80 is slightly smaller than the inner diameter of magnetic core 70 so as to provide good thermal contact between magnetic core 70 and cooling tube 80. In a preferred embodiment, the outer diameter of cooling tube 80 is 16.4 mm, and the outer diameter of extension tube 82 is 36 mm. The inner diameter of both cooling tube and extension tube 82 is 9.5 mm in the preferred embodiment.

The top of cooling tube 80 is preferably positioned below the top of magnetic core 70. The distance between the core top and the cooling tube top is preferably greater than 5 mm. The positioning of the cooling tube 80 inside core 70 increases the coupler Q-factor. In a preferred embodiment, the distance between the core top and the cooling tube top is 10 mm.

To limit propagation of visible light through the wall of reentrant cavity 40 and heating of electromagnetic coupler 70, a reflective coating 110 may be deposited on the atmospheric side of cavity wall 40a of reentrant cavity 40. The visible light is reflected from the cavity wall into lamp envelope 30 and eventually radiates from the lamp envelope surface, thereby increasing the total light output.

Electrodeless lamp 12 further includes a spacer structure disposed between electromagnetic coupler 32 and an inside wall 40a of reentrant cavity 40. In the embodiment of FIG. 1, the spacer structure includes an upper spacer 90 and a lower spacer 92. Spacers 90 and 92 are made from a dielectric material which has low thermal connectivity and which is resistant to high temperatures up to 250° C. In a preferred embodiment, spacers 90 and 92 are made of tetrafluoroethylene, known under the trade name Teflon, but other materials such as high temperature plastics may be utilized. The spacers 90 and 92 are firmly affixed to magnetic core 70 at its top and bottom, respectively. The outer diameter of each spacer is slightly smaller than the inner diameter of reentrant cavity 40, so that spacers 90 and 92 define a substantially uniform gap between magnetic core 70 and cavity wall 40a. The dimension of the gap may be in a range of 1 mm to 15 mm and varies as the core diameter and the cavity diameter vary. In a preferred embodiment, the gap between magnetic core 70 and cavity wall 40a of reentrant cavity 40 is 6 mm. Such a separation of the magnetic core from the hot cavity wall decreases substantially the heat transferred from the cavity wall to induction coil 72 and magnetic core 70.

Spacer 90 may extend above magnetic core 70 by a few millimeters so as to provide a gap between the top of magnetic core 70 and a closed end 40b of reentrant cavity 40, as shown in FIG. 1. The height (axial dimension) of the spacers may be in a range of 3 mm to 30 mm. In a preferred embodiment, the height of spacer 90 is 15 mm and the height of spacer 92 is 10 mm. The dimension of the gap between magnetic core 70 and closed end 40b of reentrant cavity 40 may be in a range of 5 mm to 35 mm and in a preferred embodiment is 10 mm. A distance between spacers 90 and 92 may be in a range of 1 mm to 300 mm. The gap reduces the heat transfer from the hot closed end 40b to the magnetic core 70.

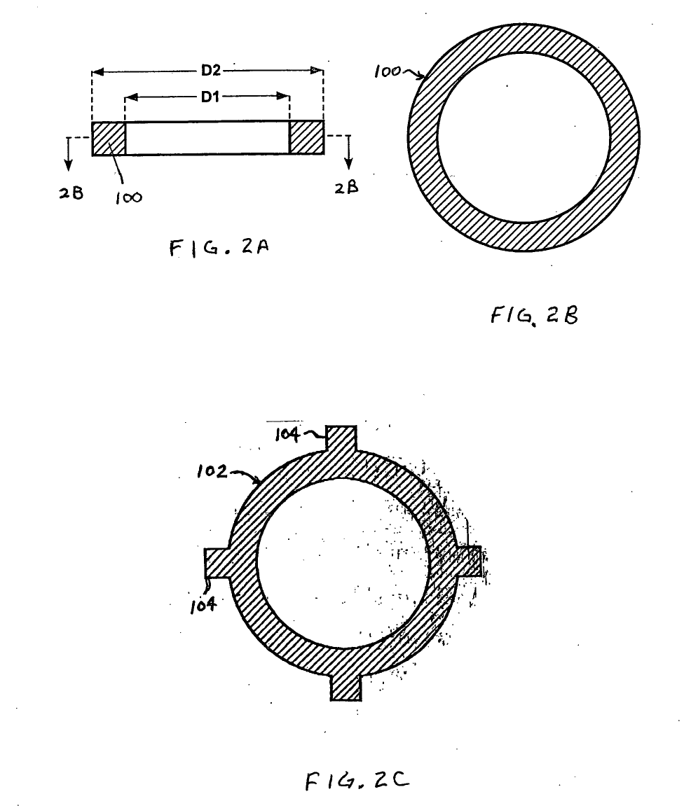

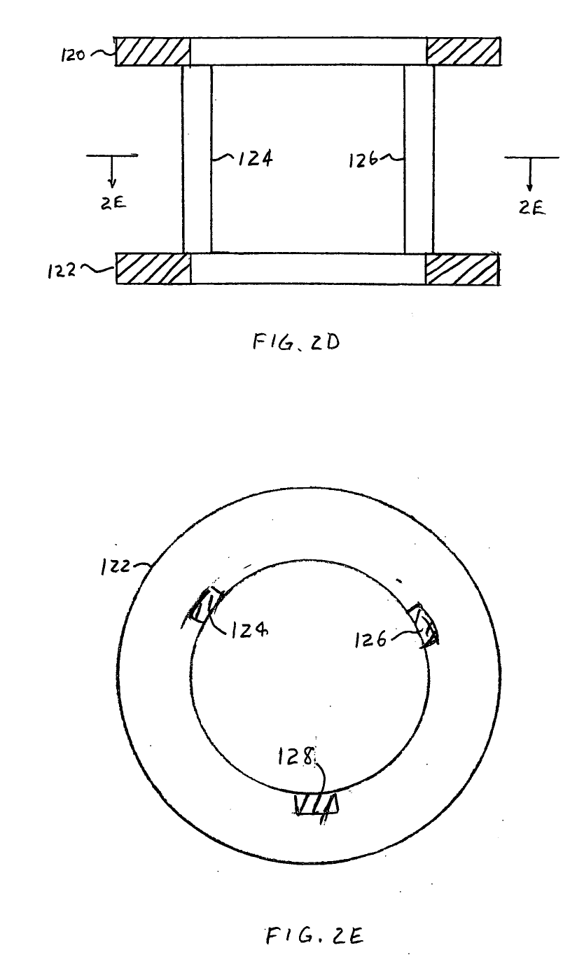

A first embodiment of a spacer suitable for spacers 90 and 92 is shown in FIGS. 2A and 2B. A spacer 100 is formed as a hollow cylindrical ring having an inside diameter D1 and an outside diameter D2. The cross section of spacer 100 may be square or rectangular. Inside diameter D1 is slightly larger than the outside diameter of magnetic core 70, and outside diameter D2 is slightly smaller than the inside diameter of reentrant cavity 40. In the embodiment of FIGS. 2A and 2B, the cavity wall touches the whole outside surface of spacer 100.

A second embodiment of a spacer suitable for spacers 90 and 92 is shown in FIG. 2C. A cross-type spacer 102 has a hollow cylindrical configuration with protrusions 104. The embodiment of FIG. 2C has four radial protrusions 104 at 90 degree intervals around spacer 102. In another embodiment, the spacer has three equally spaced protrusions. Three or more protrusions may be utilized within the scope of the invention. Spacer 102 including protrusions 104 is dimensioned such that the outer ends of protrusions 104 contact cavity wall 40a of reentrant cavity 40. The cross-type spacer shown in FIG. 2C has a much smaller area of contact with cavity wall 48, as compared with the spacer 100 shown in FIGS. 2A and 2B. The reduction of the contact area results in less heat transferred from the cavity wall to magnetic core 70 and induction coil 72 and produces lower temperatures of magnetic core 70 and induction coil 72.

An embodiment of a spacer structure in accordance with the invention is shown in FIGS. 2D and 2E. An upper ring 120 and a lower ring 122 are joined by struts 124, 126 and 128. The inside diameter of rings 120 and 122 is slightly larger than the outside diameter of magnetic core 70, and the outside diameter of rings 120 and 122 is slightly smaller than the inside diameter of reentrant cavity 40. Struts 124, 126 and 128 may be dimensioned according to the desired spacing between rings 120 and 122 in the lamp. It will be understood that rings with protrusions may be utilized in the spacer structure of FIGS. 2D and 2E.

A variety of different spacer structures and configurations may be utilized within the scope of the invention. The primary function of the spacer structure is to establish a gap between the electromagnetic coupler and the inside wall of the reentrant cavity.

To obtain a high Q-factor for coupler 32, magnetic core 70 and extension tube 82 of the cooling structure should be separated. Experiments have shown that to exclude the effect of the copper of extension tube 82 on the coupler Q-factor, the distance between the bottom of the magnetic core 70 and the extension tube 82 should be larger than 10 mm. In a preferred embodiment, coil spacer 84 is a glass cylinder with a length of 12 mm and an outer diameter of 25 mm, and is positioned between magnetic core 70 and extension tube 82.

The lamp operates as follows. A high frequency voltage is applied to induction coil 72 from a signal generator and an amplifier via a matching network (not shown). The high frequency voltage is preferably in a frequency range of 20 kHz to 20 MHz. When the azimuthal electric field in the lamp envelope in an area adjacent to reentrant cavity 40 reaches its breakdown value, an inductively-coupled plasma appears around the reentrant cavity near the center of the magnetic core 70 and induction coil 72. As the plasma power heats amalgam 60 via convection and heat conduction through tubulation 42, the mercury vapor pressure increases and thereby causes an increase in ultraviolet radiation output. As a result, visible light generated from phosphor coating 52 excited by the ultraviolet radiation also increases until reaching a maximum value at a mercury pressure of about 6 milliTorr. The lamp consumes high frequency power in a range of 50 watts to 500 watts.

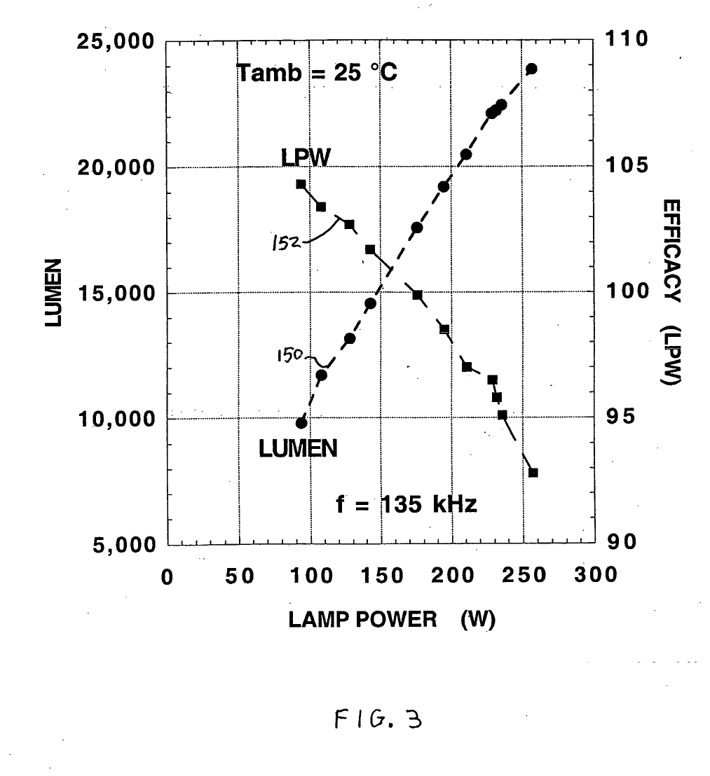

Referring to FIG. 3, light output (curve 150) and lamp efficacy (curve 152) are plotted as a function of lamp power at an ambient temperature 25° C. and a driving frequency of 135 kHz. The distance between the cavity wall 40a and induction coil 72 having 32 turns wrapped around magnetic core 70 was 3 mm. The light output 150 increases monotonically with lamp power from 100 watts to 260 watts, while the lamp efficacy 152 decreases from 104 lumens per watt at 100 watts to 92 lumens per watt at 260 watts.

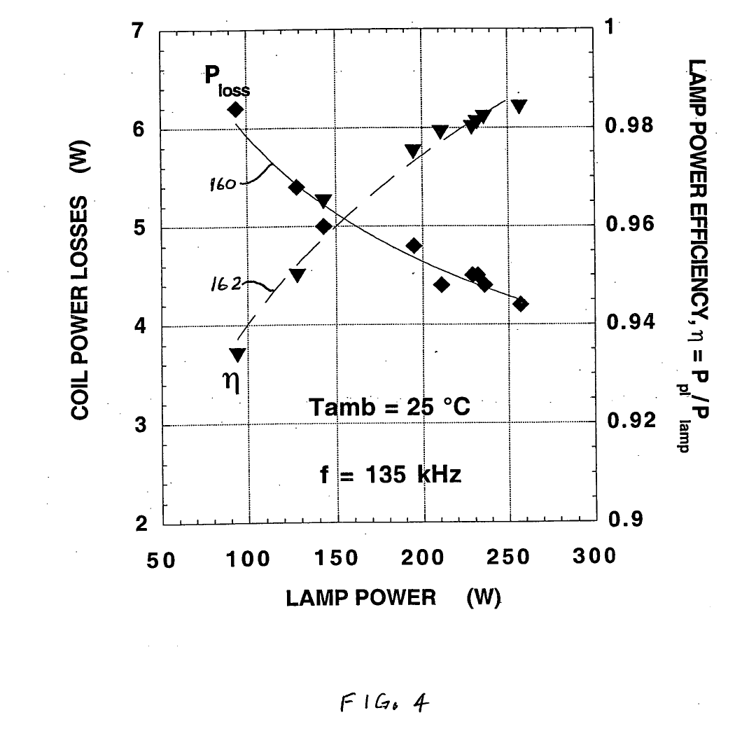

The excellent lamp efficacy is achieved due to high plasma power efficiency, which is due to very low coil/core power losses. Referring to FIG. 4, coil/core power losses (curve 160) and lamp power efficiency (curve 162) are plotted as a function of lamp power. Coil/core power losses decrease from 6 watts at a lamp power of 100 watts to 4 watts at a lamp power of 260 watts. Consequently, the lamp power efficiency, Pₚₗ/Pₗₐₘₚ, increases from 0.94 at a lamp power of 100 watts to 0.985 at a lamp power of 260 watts.

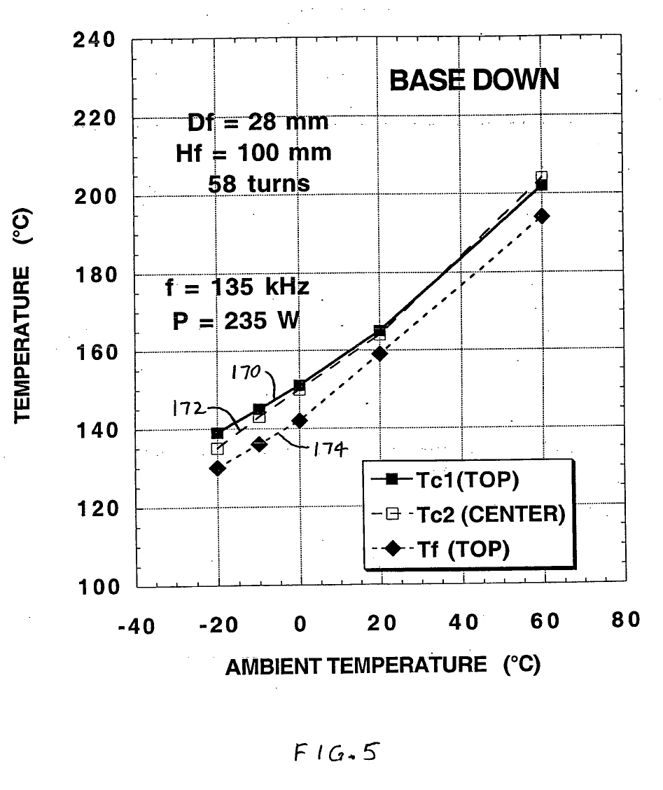

Coil/core power losses are low due to the high plasma density and hence low plasma electric field at high plasma power, where the plasma power is greater than 200 watts. Coil/core power losses are also low because of low coil and core temperatures which, at a lamp power of 235 watts, are about 160° C. The power losses in the ferrite material (MN-80 or 2H8) are still low even at ferrite temperatures of 1600 to 180° C. Core and coil temperatures as a function of ambient temperature are shown in FIG. 5 for a lamp having a gap between the coil and the cavity walls of 2.5 mm and a lamp power of 235 watts. The lamp was in the base down position. The coil top temperature is indicated by a curve 170, the coil center temperature is indicated by curve 172 and the core top temperature is indicated by curve 174. At all ambient temperatures, the coil temperature is slightly higher (5°-7° C.) than the core temperature, but even at an ambient temperature of +60° C., the coil temperature is not greater than 205° C.

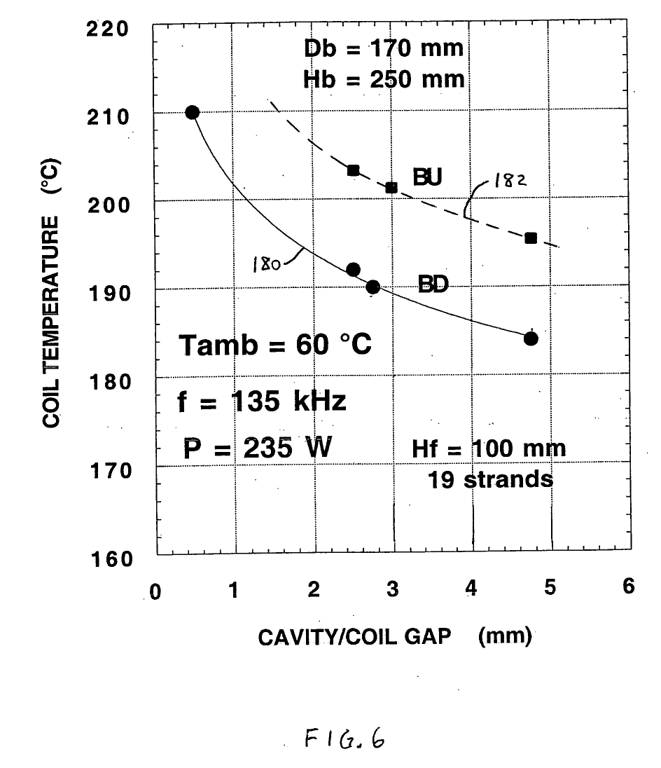

The increase in the gap between the core and the cavity wall results in a decrease of the core and coil temperatures due to less effective transfer of heat from the cavity wall to magnetic core 70 and induction coil 72. This is illustrated in FIG. 6 where coil temperature is plotted as a function of the gap dimension for a base down lamp position (curve 180) and a base up lamp position (curve 182). The lamp power was 235 watts and the ambient temperature was +60° C. The coil temperature decreases as the gap dimension increases and at a gap dimension of 3.5 mm, the coil temperature and the core temperature are below 200° C. for the base up and base down positions.

The increase of the gap between the cavity wall and the coil/core decreases the coupling between the coil/core and the inductively-coupled plasma. To maintain the discharge and the plasma, the coil current generating the magnetic field to maintain the discharge is increased. As a result, the coil/core power losses increase. This phenomenon, as discussed in U.S. Pat. Nos. 5,621,265 and 6,081,070, causes a decrease of the lamp power efficiency and hence lighting efficacy. However, for a lamp operating at a power of 200 to 250 watts, an increase in coil power losses even by 50 percent, from 3 watts to 4.5 watts, does not have any noticeable effect on the lamp power efficiency. Thus, the efficacy of an electrodeless fluorescent lamp operated at a high power of 200 to 300 watts and a frequency of 100 to 400 kHz is not sensitive to the variation (up to 10-15 mm) of the gap dimension between the cavity wall and the core/coil.

A novel method is described for reducing coil and core temperatures without reducing lamp power efficiency and hence visible light efficacy. The method takes advantage of the decrease in inductive electric field in the plasma in high power (150-500 watts) electrodeless lamps, which have much higher plasma density than low power (20-50 watts) electrodeless lamps. The decrease in electric field causes a decrease of the magnetic field needed to maintain the plasma. As a result, the coil/core power losses substantially decrease to a level of 2 to 3 watts. For electrodeless lamps operating at a power of 150 to 500 watts, this power loss is negligible and constitutes less than 2 percent of the total lamp power. Even a two-fold increase in the coil/core power losses does not appreciably affect the lamp power efficiency.

The insensitivity of the high power lamp efficacy to variation of the coil/core power losses within a range of 2 to 6 watts enables an improvement of coil/core cooling at the expense of coil/core losses. This is accomplished by increasing spacing between the coil/core and the cavity wall and cavity top, which results in a reduction of heat transfer from the hot cavity wall and cavity top to the coil/core.

At the same time, the increase in distance between the cavity wall and the coil/core degrades the coil/core coupling with the inductive plasma. Indeed, the increase in spacing between the coil/core and the plasma causes a decrease of the coupling coefficient. It was shown in the prior art that the coupling coefficient k depends strongly on the plasma and the coil radii, as k equals R_{c}²/Rₚₗ². Consequently, the decrease of the coupling coefficient is accompanied by an increase of the coil current and voltage and hence, by an increase of the magnetic field through the magnetic core. This leads to an increase in coil losses (due to the coil current increase) and magnetic core losses (due to the magnetic field increase). However, since at high power Pₗₐₘₚ is much greater than Pₗₒₛₛ and is approximately equal to Pₚₗ, the lamp power efficiency Pₚₗ/Pₗₐₘₚ is not sensitive to the increase of Pₗₒₛₛ and is close to one.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. An electrodeless lamp comprising:
a bulbous lamp envelope enclosing an inert gas and a vaporizable metal fill, the lamp envelope having a reentrant cavity;
an electromagnetic coupler positioned within said reentrant cavity; and
a spacer structure disposed between said electromagnetic coupler and an inside wall of said reentrant cavity.

2. An electrodeless lamp as defined in claim 1, wherein said electromagnetic coupler comprises an induction coil positioned within said reentrant cavity and a magnetic core disposed inside said induction coil.

3. An electrodeless lamp assembly as defined in claim 2, wherein said electromagnetic coupler further comprises a cooling structure positioned inside said induction coil and thermally coupled to a lamp base.

4. An electrodeless lamp as defined in claim 1, wherein said reentrant cavity and said electromagnetic coupler have generally cylindrical configurations.

5. An electrodeless lamp as defined in claim 1, wherein said spacer structure is configured to define a gap between the electromagnetic coupler and the inside wall of said reentrant cavity in a range of 1 to 15 millimeters.

6. An electrodeless lamp as defined in claim 1, wherein spacer structure comprises at least one thermally insulating ring disposed between said electromagnetic coupler and the inside wall of said reentrant cavity.

7. An electrodeless lamp as defined in claim 1, wherein said spacer structure comprises two or more spaced-apart thermally insulating rings disposed on said electromagnetic coupler.

8. An electrodeless lamp as defined in claim 7, wherein the spaced-apart rings are joined by struts.

9. An electrodeless lamp as defined in claim 7, wherein a distance between said rings is in a range of 1 to 300 millimeters.

10. An electrodeless lamp as defined in claim 1, wherein at least part of said spacer structure is disposed between an end of said electromagnetic coupler and a closed end of said reentrant cavity.

11. An electrodeless lamp as defined in claim 1, wherein said spacer structure includes at least one spacer that extends beyond an end of said electromagnetic coupler, wherein said electromagnetic coupler is spaced from a closed end of said reentrant cavity.

12. An electrodeless lamp as defined in claim 1, wherein said spacer structure comprises at least one thermally insulating ring having protrusions.

13. An electrodeless lamp as defined in claim 1, wherein said spacer structure is fabricated of a material having low thermal conductivity.

14. An electrodeless lamp as defined in claim 1, which consumes high frequency power in a range of 50 watts to 500 watts.

15. An electrodeless lamp as defined in claim 14, wherein said high frequency power is in a range of 20 kHz to 20 MHz.

16. An electrodeless lamp as defined in claim 3, wherein said cooling structure includes a cooling tube disposed within said induction coil and an extension tube coupled between said cooling tube and a lamp base.

17. An electrodeless lamp as defined in claim 1, wherein said spacer structure comprises two or more spacers disposed on said electromagnetic coupler.

18. An electrodeless lamp as defined in claim 17, wherein said spacers each have an outside diameter that corresponds to an inside diameter of said reentrant cavity.

19. An electrodeless lamp comprising:
a bulbous lamp envelope enclosing an inert gas and a vaporizable metal fill and having a phosphor material on an inside surface thereof, the lamp envelope including a reentrant cavity;
a magnetic core positioned within said reentrant cavity;
an induction coil disposed on said magnetic core;
a cooling structure disposed inside said magnetic core and thermally coupled to a lamp base; and
a spacer structure disposed between said magnetic core and an inside wall of said reentrant cavity.

20. An electrodeless lamp as defined in claim 19, wherein said spacer structure comprises at least one thermally insulating ring disposed between said magnetic core and the inside wall of said reentrant cavity.

21. An electrodeless lamp as defined in claim 19, wherein said spacer structure comprises two or more spaced-apart thermally insulating rings positioned between said magnetic core and the inside wall of said reentrant cavity.

22. An electrodeless lamp as defined in claim 21, wherein the spaced-apart rings are joined by struts.

23. An electrodeless lamp as defined in claim 21, wherein a distance between said rings is in a range of 1 to 300 millimeters.

24. An electrodeless lamp as defined in claim 19, wherein said spacer structure includes a portion positioned between an end of said magnetic core and a closed end of said reentrant cavity.

25. An electrodeless lamp as defined in claim 19, wherein said spacer structure extends beyond an end of said magnetic core.

26. An electrodeless lamp as defined in claim 19, wherein said spacer structure comprises at least one thermally insulating ring having two or more protrusions.

27. An electrodeless lamp as defined in claim 19, wherein said spacer structure is fabricated of a material having low thermal conductivity.

28. An electrodeless lamp as defined in claim 19, wherein said cooling structure includes a cooling tube disposed within said magnetic core and an extension tube coupled between said cooling tube and the lamp base.

29. An electrodeless lamp as defined in claim 20, wherein said at least one thermally insulating ring has an inside diameter that corresponds to an outside diameter of said magnetic core and an outside diameter that corresponds to an inside diameter of said reentrant cavity.

30. An electrodeless lamp as defined in claim 19, wherein said spacer structure comprises an upper spacer and a lower spacer on said magnetic core, wherein said upper spacer extends beyond an end of said magnetic core toward a closed end of said reentrant cavity.

31. An electrodeless lamp assembly as defined in claim 19, wherein the spacer structure defines a gap between the magnetic core and the inside wall of said reentrant cavity in a range of 1 to 15 millimeters.

32. In an electrodeless lamp including a bulbous lamp envelope having a reentrant cavity and an electromagnetic coupler positioned within the reentrant cavity, a method for enhancing performance comprising:
controlling a spacing between the electromagnetic coupler and an inside wall of the reentrant cavity with a thermally insulating spacer structure.

33. A method as defined in claim 32, wherein controlling the spacing comprises spacing the magnetic core and the inside wall of the reentrant cavity by a gap having a dimension in a range of 1 to 15 millimeters.

34. An electrodeless lamp comprising:
a bulbous lamp envelope enclosing an inert gas and a vaporizable metal fill, the lamp envelope having a reentrant cavity;
an electromagnetic coupler positioned within said reentrant cavity; and
means for defining a thermally insulating gap between the electromagnetic coupler and an inside wall of the reentrant cavity.

35. An electrodeless lamp as defined in claim 34, wherein said means for defining a thermally insulating gap comprises means for defining an air gap.
